(19) United States
(12) Patent Application Publication
(10) Pub. No.: US 2019/0001515 A1
(43) Pub. Date: Jan. 3, 2019

(54) CUTTING DEVICE AND NON-TRANSITORY COMPUTER-READABLE STORAGE MEDIUM

(71) Applicant: BROTHER KOGYO KABUSHIKI KAISHA, Nagoya-shi (JP)

(72) Inventors: Mayumi NISHIZAKI, Nagoya-shi (JP); Masashi TOKURA, Nagoya-shi (JP)

(21) Appl. No.: 16/020,420

(22) Filed: Jun. 27, 2018

(30) Foreign Application Priority Data
Jun. 28, 2017 (JP) 2017-126657

(51) Int. Cl. B26D 5/00; B26D 5/02; B26D 1/60; B26F 1/38; B26D 7/01

(52) U.S. Cl. CPC B26D 5/007; B26D 5/02; H04N 1/4097; B26F 1/3813; B26D 7/015; B26D 1/60

(57) ABSTRACT

A cutting device includes a support member, a reading unit, a conveyance portion, a movement portion, a processor, and a memory. The memory stores computer-readable instructions that, when executed by the processor, instruct the cutting device to perform processes. The processes include conveying the support member in the sub-scanning direction by controlling the conveyance portion. The processes include causing the reading unit to read a support area and a determination area of the support member supporting the object to be cut that includes a target pattern, while the support member is being conveyed in the sub-scanning direction. The processes include detecting a same position in the main scanning direction as a specific position when, in first image data generated by the reading of the determination area, abnormal pixels are continuously present for a predetermined number or more in the sub-scanning direction at the same position in the main scanning direction.

### CROSS-REFERENCE TO RELATED APPLICATION

This application claims priority to Japanese Patent Application No. 2017-126657 filed on Jun. 28, 2017, the disclosure of which is herein incorporated by reference in its entirety.

### BACKGROUND

The present disclosure relates to a cutting device and a non-transitory computer-readable storage medium.

A processing device is known that generates cutting data of a cutting device that cuts a pattern from a sheet-like object to be cut, by moving the object to be cut and a cutting blade relative to each other, in accordance with the cutting data. When noise, such as black dots or the like, is included in image data read by a reading unit as a result of dust, dirt or the like on the object to be cut, the above-described processing device performs processing to generate processing data that eliminates the noise from the image data.

### SUMMARY

The above-described processing device does not take into consideration a case in which dust, dirt or the like is attached to the reading unit. The above-described processing device sometimes generates the processing data in a state in which the processing data includes noise resulting from the dust, or dirt attached to the reading unit and the like.

Various embodiments of the general principles described herein provide a cutting device and a non-transitory computer-readable storage medium that are capable of detecting abnormal pixels.

Embodiments herein provide a cutting device including a support member, a reading unit, a conveyance portion, a movement portion, a processor, and a memory. The support member includes a support area configured to support an object to be cut, and a determination area provided on outer sides of the support area and having a same color. The reading unit includes a plurality of imaging elements disposed side by side in a main scanning direction. The conveyance portion is configured to convey the support member in a sub-scanning direction that is orthogonal to the main scanning direction. The movement portion is configured to move, in the main scanning direction, a cutting blade that cuts the object to be cut supported by the support member. The memory stores computer-readable instructions that, when executed by the processor, instruct the cutting device to perform processes. The processes include conveying the support member in the sub-scanning direction by controlling the conveyance portion. The processes include causing the reading unit to read the support area and the determination area of the support member supporting the object to be cut that includes a target pattern, while the support member is being conveyed in the sub-scanning direction. The processes include detecting a same position in the main scanning direction as a specific position when, in first image data generated by the reading of the determination area, abnormal pixels are continuously present for a predetermined number or more in the sub-scanning direction at the same position in the main scanning direction. Each of the abnormal pixels is a pixel having a value that is different to a value of an adjacent pixel in the main scanning direction. The processes include generating cutting data on the basis of second image data generated by the reading of the support area. The cutting data is data for cutting the target pattern from the object to be cut. The processes include cutting the target pattern from the object to be cut by controlling the conveyance portion and the movement portion in accordance with the generated cutting data.

Embodiments herein also provide a non-transitory computer-readable medium storing computer-readable instructions that, when executed, instruct a processor of a cutting device provided with a support member, a reading unit, and a conveyance portion to perform processes. The processes include conveying the support member in a sub-scanning direction that is orthogonal to a main scanning direction by controlling the conveyance portion. The support member is configured to support an object to be cut that includes a target pattern. The conveyance portion is configured to convey the support member in the sub-scanning direction that is orthogonal to the main scanning direction. The processes include causing the reading unit to read a support area and a determination area of the support member supporting the object to be cut, while the support member is being conveyed in the sub-scanning direction. The support area is an area in which the support member is configured to support the object to be cut. The determination area is provided on outer sides of the support area and having a same color. The reading unit includes a plurality of imaging elements disposed side by side in the main scanning direction. The processes include detecting a same position in the main scanning direction as a specific position when, in first image data generated by the reading of the determination area, abnormal pixels are continuously present for a predetermined number or more in the sub-scanning direction at the same position in the main scanning direction. Each of the abnormal pixels is a pixel having a value that is different to a value of an adjacent pixel in the main scanning direction. The processes include generating cutting data on the basis of second image data generated by the reading of the support area. The cutting data is data for cutting the target pattern from the object to be cut.

### BRIEF DESCRIPTION OF THE DRAWINGS

Embodiments will be described below in detail with reference to the accompanying drawings in which:

FIG. 1 is a perspective view of a cutting device;

FIG. 2 is a plan view of a support member supporting an object to be cut;

FIG. 3 is a block diagram showing an electrical configuration of the cutting device;

FIG. 4 is a flowchart of main processing according to a first embodiment;

FIG. 5 is a flowchart of main processing according to the first embodiment, and is a continuation of FIG. 4;

FIG. 6 is an explanatory diagram of a pixel group representing a first area, and a pixel group representing a second area;

FIG. 7 is an explanatory diagram of a process to generate cutting data on the basis of a second image representing a target pattern;

FIG. 8 is a flowchart of main processing according to a second embodiment;

FIG. 9 is a flowchart of main processing according to the second embodiment, and is a continuation of FIG. 8;

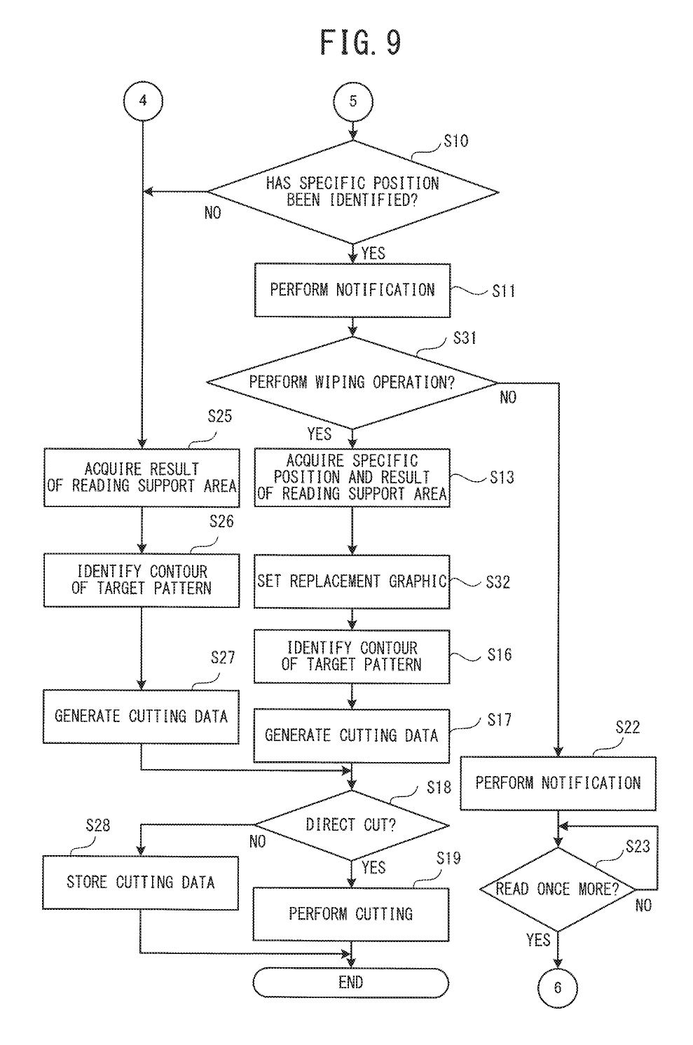

FIG. 10 is an explanatory diagram of a process to generate the cutting data on the basis of the second image representing the target pattern; and

FIG. 11 is an explanatory diagram of a process to generate the cutting data on the basis of the second image representing the target pattern.

### DETAILED DESCRIPTION

First and second embodiments of the present disclosure will be explained sequentially with reference to the drawings. The accompanying drawings are used to illustrate technological features that can be adopted by the present disclosure, and device configurations and the like described herein are merely explanatory examples and the present disclosure is not limited thereto.

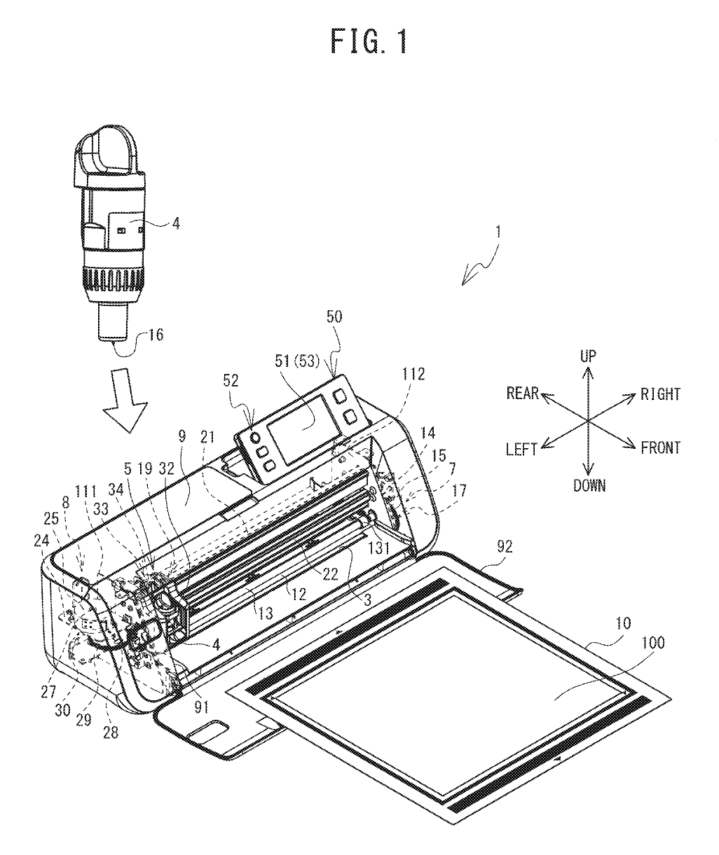

A physical configuration of a cutting device 1 that is common to the first and second embodiments will be explained with reference to FIG. 1 to FIG. 3. In the following explanation, the lower left side, the upper right side, the lower right side, the upper left side, the upper side, and the lower side respectively define the left side, the right side, the front side, the rear side, the upper side, and the lower side of the cutting device 1 and a support member 10. Specifically, an extending direction of a main body cover 9 to be described later is the left-right direction. A surface on which an operation portion 50 is arranged is a top surface of the cutting device 1. A longitudinal direction of the support member 10 is the front-rear direction, and a lateral direction of the support member 10 is the left-right direction.

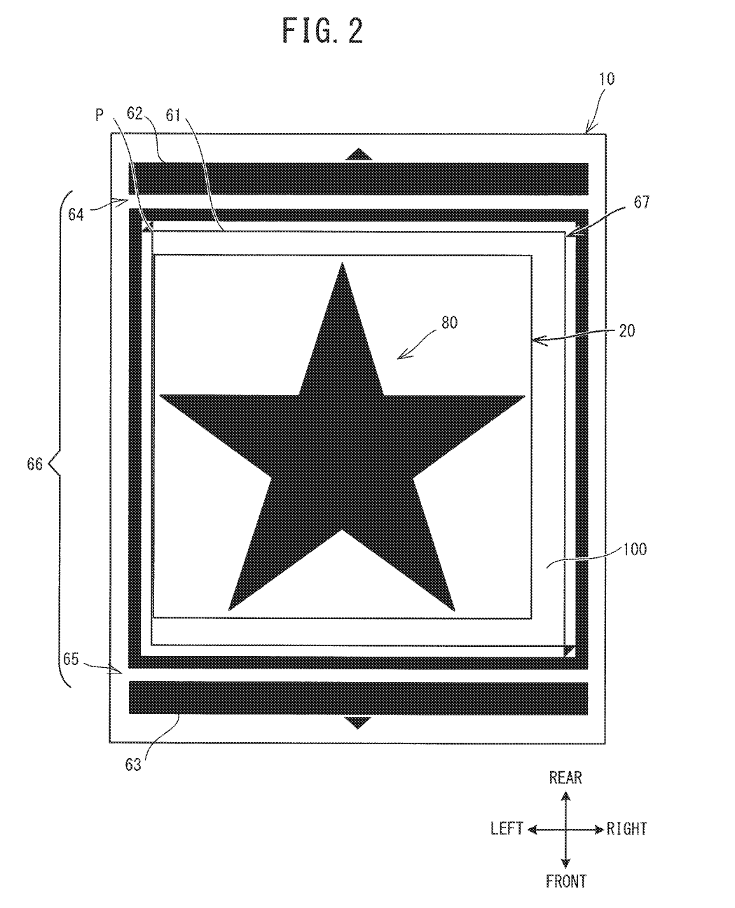

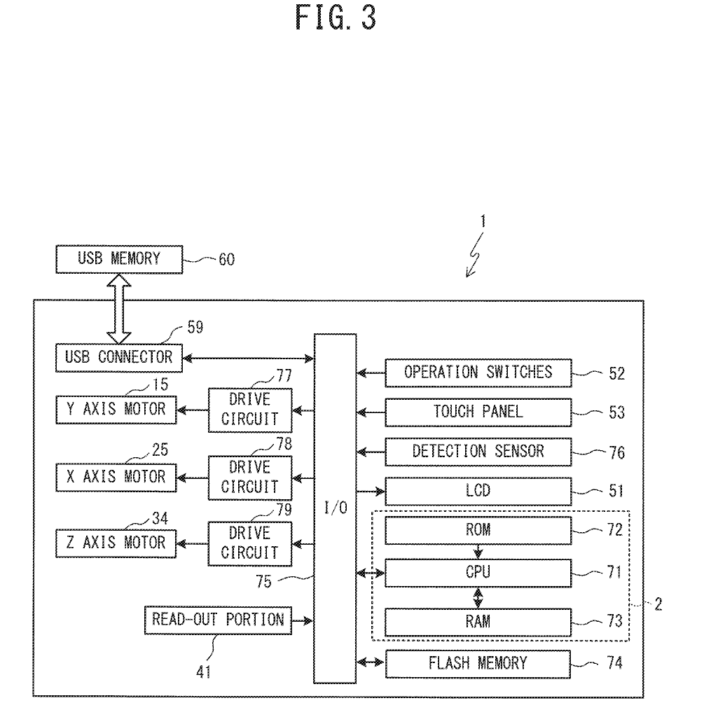

As shown in FIG. 1 and FIG. 3, the cutting device 1 is provided with the main body cover 9, a platen 3, a head 5, a conveyance portion 7, a movement portion 8, a reading unit 41 and a control portion 2. The cutting device 1 can cut a sheet-like object to be cut 20 that is supported by the support member 10, in accordance with cutting data. As shown in FIG. 1, the support member 10 is conveyed in the front-rear direction by the cutting device 1 in a posture in which the longitudinal direction of the support member 10 is the front-rear direction. As shown in FIG. 2, the support member 10 is a rectangular mat having a predetermined thickness. The support member 10 is made from a synthetic resin material, for example. A rectangular frame line 61 and thick lines 62 and 63 that extend in the left-right direction are printed on the top surface of the support member 10. The frame line 61 is arranged between the thick lines 62 and 63 in the front-rear direction. The support member 10 includes a support area 67 that can support the object to be cut 20, and a determination area 66 that are a same color and that are provided on the outside of the support area 67. Namely, the determination area 66 has a uniform color. The support area 67 is a substantially rectangular area inside the frame line 61. The cutting device 1 can cut the object to be cut 20 arranged inside the support area 67. An adhesive layer 100, to which an adhesive is applied, is provided in the support area 67. The object to be cut 20 is supported by being adhered to the adhesive layer 100. The object to be cut 20 is, for example, paper, a work cloth, a plastic sheet, or the like. The determination area 66 includes a first area 64 and a second area 65 that are positioned on both sides of the support area 67 in a sub-scanning direction (the front-rear direction) that will be described later. The first area 64 is an area between the frame line 61 on the rear side and the thick line 62, and is on the rear side of the support area 67. The second area 65 is an area between the frame line 61 on the front side and the thick line 63, and is on the front side of the support area 67. The first area 64 and the second area 65 extend in the left-right direction. For example, a color of the first area 64 is white, and also a color of the second area 65 is white (Refer to FIG. 2). Namely, the first area 64 and the second area 65 have the same color. In other words, the first area 64 and the second area 65 have the uniform color.

As shown in FIG. 1, the main body cover 9 is a housing having a substantially rectangular cuboid shape that is long in the left-right direction. An open portion 91, a cover 92, and the operation portion 50 are provided on the main body cover 9. The open portion 91 is an opening provided in a front surface portion of the main body cover 9. The cover 92 is a plate-shaped member that is long in the left-right direction. The lower end side of the cover 92 is rotatably supported on the main body cover 9. The open portion 91 is opened by opening the cover 92. The open portion 91 is closed by closing the cover 92. In FIG. 1, the cover 92 is open and the open portion 91 is thus open.

The operation portion 50 is provided on a right side section on the top surface of the main body cover 9. The operation portion 50 is provided with a liquid crystal display (LCD) 51, a plurality of operation switches 52, and a touch panel 53. Images including various items, such as commands, illustrations, setting values, and messages, are displayed on the LCD 51. The touch panel 53 is provided on the surface of the LCD 51. A user performs a depression operation (this operation is referred to as a “panel operation” below) on the touch panel 53, using one of a finger and a stylus pen. In the cutting device 1, it is identified which item has been selected in correspondence to a depressed position detected by the touch panel 53. Using the operation switches 52 and the touch panel 53, the user can select a pattern displayed on the LCD 51, can set various parameters, and can perform an input operation or the like.

The platen 3 is provided inside the main body cover 9. The platen 3 is a plate-shaped member that extends in the left-right direction. The support member 10 supporting the object to be cut 20 can be placed on the platen 3, which supports the bottom surface of the support member 10. The support member 10 is placed on the platen 3 in a state in which the open portion 91 is open.

The head 5 is provided with a carriage 19, a mounting portion 32, and an up-down drive mechanism 33. The mounting portion 32 and the up-down drive mechanism 33 are arranged, respectively, to the front and the rear of the carriage 19. A cartridge 4, which has a cutting blade 16, can be mounted on the mounting portion 32. The cartridge 4 is mounted on the mounting portion 32 in a state in which the cutting blade 16 is arranged on a lower end of the cartridge.

The up-down drive mechanism 33 moves the mounting portion 32 in a direction causing the mounting portion 32 to come close to the platen 3 (downward) and a direction causing the mounting portion 32 to separate from the platen 3 (upward). The up-down drive mechanism 33 causes a rotational movement of a Z axis motor 34 to decelerate, converts the rotational movement to an up-down movement, and transmits a driving force to the mounting portion 32. The up-down drive mechanism 33 drives the mounting portion 32 and the cartridge 4 in the up-down direction (also referred to as a Z direction). The Z axis motor 34 is a pulse motor, for example.

The conveyance portion 7 conveys the support member 10 in the sub-scanning direction orthogonal to a main scanning direction. The main scanning direction and the sub-scanning direction are the left-right direction and the front-rear direction, respectively. The conveyance portion 7 is configured to be capable of conveying the support member 10 set on the platen 3 in the front-rear direction (also referred to as a Y direction) of the cutting device 1. The conveyance portion 7 is provided with a drive roller 12, a pinch roller 13, an attachment frame 14, a Y axis motor 15, and a deceleration mechanism 17. A pair of side wall portions 111 and 112 are provided inside the main body cover 9 such that the pair of side wall portions 111 and 112 face each other in the left-right direction. The side wall portion 111 is positioned on the left side of the platen 3. The side wall portion 112 is positioned on the right side of the platen 3. The drive roller 12 and the pinch roller 13 are rotatably supported between the side wall portions 111 and 112. The drive roller 12 and the pinch roller 13 extend in the left-right direction (also referred to as an X direction) of the cutting device 1, and are disposed to be aligned in the up-down direction. A roller portion (not shown in the drawings) is provided on a left portion of the pinch roller 13, and a roller portion 131 is provided on a right portion of the pinch roller 13.

The attachment frame 14 is fixed to an outer surface side (the right side) of the side wall portion 112. The Y axis motor 15 is attached to the attachment frame 14. The Y axis motor 15 is a pulse motor, for example. An output shaft of the Y axis motor 15 is fixed to a drive gear (not shown in the drawings) of the deceleration mechanism 17. The drive gear meshes with a driven gear (not shown in the drawings). The driven gear is fixed to the leading end of the right end portion of the drive roller 12.

When the support member 10 is conveyed, a section on the outer left side of the support area 67 is clamped between the drive roller 12 and the roller portion (not shown in the drawings) on the left side of the pinch roller 13. A section on the outer right side of the support area 67 is clamped between the drive roller 12 and the roller portion 131. When the Y axis motor 15 is driven in the forward direction and the reverse direction, the rotational movement of the Y axis motor 15 is transmitted to the drive roller 12 via the deceleration mechanism 17. In this way, the support member 10 is conveyed to the front or to the rear.

The movement portion 8 is configured so as to be able to move the head 5 in a direction that intersects a conveyance direction of the support member 10, namely, in the X direction. In other words, the movement direction of the head 5 is orthogonal to the conveyance direction of the support member 10. The movement portion 8 is provided with a pair of guide rails 21 and 22, an attachment frame 24, an X axis motor 25, a drive gear 27 and a driven gear 29 that function as a deceleration mechanism, a transmission mechanism 30 and the like. The guide rails 21 and 22 are fixed between the side wall portion 111 and the side wall portion 112. The guide rails 21 and 22 are positioned to the rear of and above the pinch roller 13. The guide rails 21 and 22 extend substantially in parallel to the pinch roller 13, namely, in the X direction. The carriage 19 of the head 5 is supported by the guide rails 21 and 22 so as to be able to move in the X direction along the guide rails 21 and 22.

The attachment frame 24 is fixed to the outer surface side (the left side) of the side wall portion 111. The X axis motor 25 is attached to the rear of the attachment frame 24, in a downward direction. The drive gear 27 is fixed to an output shaft of the X axis motor 25. The X axis motor 25 is a pulse motor, for example. The driven gear 29 meshes with the drive gear 27. The transmission mechanism 30 includes a pair of timing pulleys (not shown in the drawings) and an endless timing belt that is bridged between the pair of timing pulleys. A timing pulley 28 that is one of the timing pulleys is provided on the attachment frame 24 so as to be capable of rotating integrally with the driven gear 29. The other timing pulley is attached to the attachment frame 14. The timing belt extends in the X direction and is coupled to the carriage 19.

The movement portion 8 moves the cutting blade 16, which cuts the object to be cut 20 supported on the support member 10, in the main scanning direction. The movement portion 8 converts the rotational movement of the X axis motor 25 to a movement in the X direction, and transmits the X direction movement to the carriage 19. When the X axis motor 25 is driven in the forward direction or the reverse direction, the rotational movement of the X axis motor 25 is transmitted to the timing belt via the drive gear 27, the driven gear 29, and the timing pulley 28. In this way, the carriage 19 is moved to the left or to the right. Thus, the head 5 moves in the X direction.

The reading unit 41 is, for example, a contact image sensor (CIS). Although not illustrated in detail, the reading unit 41 is positioned to the rear of the guide rail 22 (not shown in the drawings), and is provided with imaging elements (hereinafter referred to as a “line sensor”), a light source, and a lens. The line sensor of the reading unit 41 shown in FIG. 3 has a plurality of imaging elements disposed side by side in the main scanning direction. The line sensor is, for example, a photodiode array in which light receiving elements are aligned one-dimensionally. The line sensor of the reading unit 41 reads an image of the object to be cut 20 supported on the support member 10 and outputs image data that is read by the reading unit 41. The line sensor of the reading unit 41 extends in the main scanning direction (the X direction, the left-right direction), and a light receiving portion thereof is oriented downward. The light source is provided in a downward direction, and irradiates light toward the object to be cut 20 downwardly. The irradiated light is reflected back by the object to be cut 20. The lens concentrates the light reflected back from the object to be cut 20. The concentrated light is received by the imaging elements of the line sensor. A dimension of the support member 10 in the X direction is substantially the same as a length of the reading unit 41 in the X direction. In a state in which the bottom surface of the reading unit 41 is caused to be close to the top surface of the object to be cut 20 supported on the support member 10, the reading unit 41 reads the image on the top surface of the object to be cut 20 that is positioned in a reading range. The control portion 2 controls the reading unit 41, the conveyance portion 7, and the movement portion 8. The control portion 2 causes the image of the top surface of the support member 10, on which the object to be cut 20 is placed in the reading range, to be read, while the support member 10 is being conveyed by the conveyance portion 7. In this way, the reading unit 41 can be caused to read the top surface of the support member 10 including the entire top surface of the object to be cut 20.

An electrical configuration of the cutting device 1 will be explained with reference to FIG. 3. As shown in FIG. 3, the cutting device 1 is provided with a CPU 71, a ROM 72, a RAM 73, and an input/output (I/O) interface 75. The CPU 71 is electrically connected to the ROM 72, the RAM 73, and the I/O interface 75. The control portion 2 is configured by the CPU 71, the ROM 72, and the RAM 73. The CPU 71 performs overall control of the cutting device 1. The ROM 72 stores various programs and the like used to operate the cutting device 1. The programs include, for example, a cutting program that causes the cutting device 1 to execute main processing to be described later. The RAM 73 temporarily stores various programs, various data, setting values input by operation of the operation switches 52 and the like, and computation results of computational processing performed by the CPU 71 and the like.

A flash memory 74, the reading unit 41, the LCD 51, a detection sensor 76, a USB connector 59, drive circuits 77 to 79, the operation switches 52, and the touch panel 53 are also connected to the I/O interface 75. The flash memory 74 is a nonvolatile storage element that stores various parameters and the like.

The reading unit 41 reads the image and generates the image data representing the image. A two-dimensional coordinate system (hereinafter referred to as an “image coordinate system”) is set for the image represented by the image data. The control portion 2 controls the LCD 51 and causes the image to be displayed. The LCD 51 can perform notification of various commands. The detection sensor 76 detects the rear end of the support member 10 set on the platen 3. The detection sensor 76 is provided on a bottom surface portion of the carriage 19, for example. A USB memory 60 can be connected to the USB connector 59. When the USB memory 60 is connected to the USB connector 59, the control portion 2 can access various storage areas provided in the USB memory 60. The drive circuits 77 to 79 respectively drive the Y axis motor 15, the X axis motor 25, and the Z axis motor 34. The control portion 2 controls the Y axis motor 15, the X axis motor 25, the Z axis motor 34 and the like on the basis of the cutting data, and thus causes the cutting of the object to be cut 20 on the support member 10 to be automatically performed. The cutting data includes coordinate data used to control the conveyance portion 7 and the movement portion 8. The coordinate data is represented using a cutting coordinate system that is set within the support area 67. An origin of the cutting coordinate system is a point P at the rear left of the rectangular support area 67. The cutting coordinate system is set such that the left-right direction is the X direction, and the front-rear direction is the Y direction. The cutting coordinate system can be associated with the image coordinate system, using the parameters and the like stored in the flash memory 74.

An operation by which the cutting device 1 cuts the object to be cut 20 in accordance with the cutting data will be briefly explained. The cutting device 1 controls the conveyance portion 7 and the movement portion 8 in a state in which the cutting blade 16 is separated from the support member 10, and thus moves the object to be cut 20 placed on the support member 10 to a cutting start position indicated by the cutting data. In the cutting start position, the cutting device 1 drives the Z axis motor 34 and moves the cutting blade 16 to a cutting position in which the cutting blade 16 slightly pierces the support member 10. By controlling the conveyance portion 7 and the movement portion 8 in accordance with the cutting data, the cutting device 1 moves the support member 10 and the cutting blade 16 relative to each other in the Y direction and the X direction. In this way, the cutting device 1 cuts the object to be cut 20 in accordance with the cutting data.

An overview of the main processing executed by the cutting device 1 of the first and second embodiments will be explained, using as an example a case of cutting a target pattern 80 that is drawn on the object to be cut 20. When a set mode is a first mode, the main processing is processing to cut the object to be cut 20 supported on the support member 10, in accordance with the cutting data, after the cutting data is generated on the basis of the image data of the object to be cut 20 read by the reading unit 41. In the main processing, the control portion 2 controls the conveyance portion 7 and thus conveys the support member 10 in the sub-scanning direction. While causing the support member 10 to be conveyed in the sub-scanning direction, the control portion 2 causes the reading unit 41 to read the determination area 66 and the support area 67 of the support member 10 supporting the object to be cut 20 that includes the target pattern 80. First image data is generated by the reading of the determination area 66. When, in the generated first image data, abnormal pixels, which have a different value to a value of an adjacent pixel in the main scanning direction, are continuously present for a predetermined number or more in the sub-scanning direction at the same position in the main scanning direction, the control portion 2 detects that same position in the main scanning direction as a specific position. Second image data is generated by the reading of the support area 67. The control portion 2 generates the cutting data to cut the target pattern 80 of the object to be cut 20 on the basis of the generated second image data. The control portion 2 controls the conveyance portion 7 and the movement portion 8 in accordance with the generated cutting data, and thus cuts the target pattern 80 of the object to be cut 20.

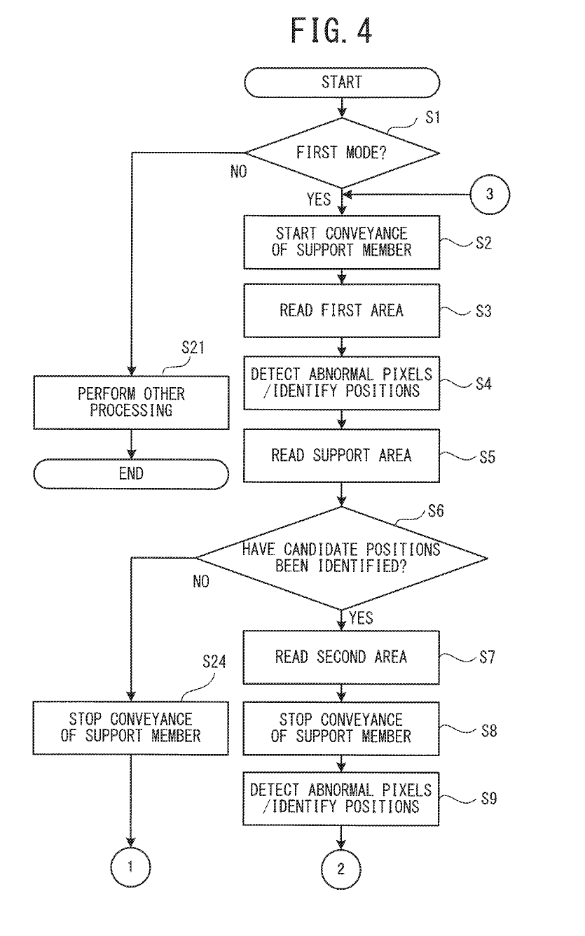

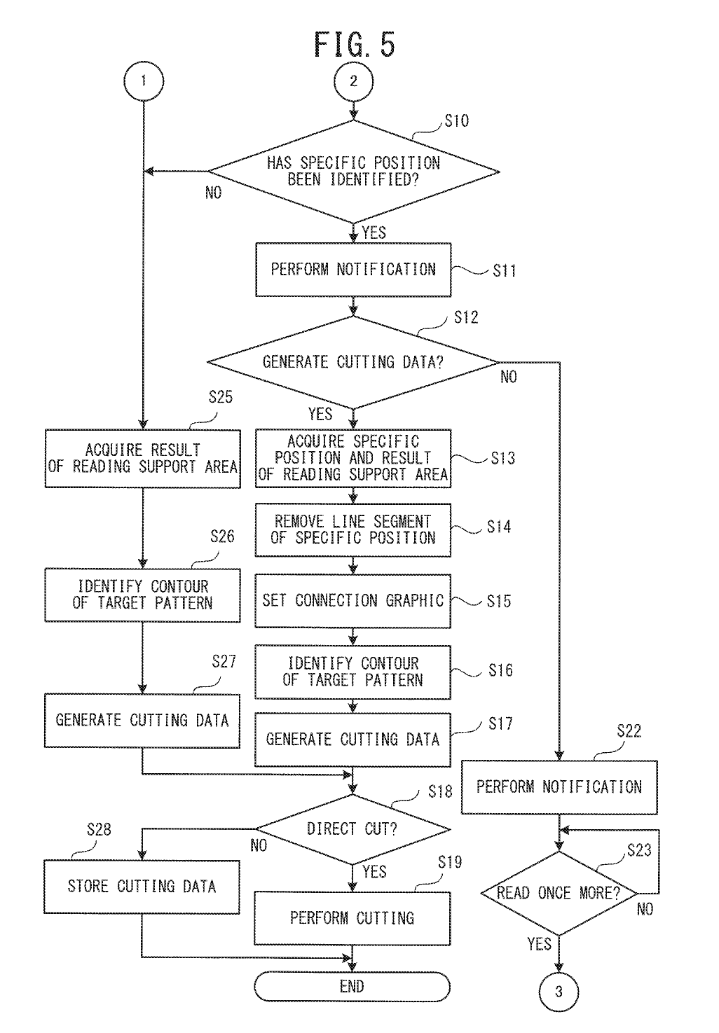

The main processing according to the first embodiment will be explained with reference to FIG. 4 to FIG. 7. When a start command is input by a panel operation or the like, the control portion 2 of the cutting device 1 reads out, to the RAM 73, the cutting program stored in the flash memory 74, and executes the main processing in accordance with commands included in the cutting program. When a command to perform one of direct cut processing, scan to cut data processing, scan to USB processing, and a background scan is input by the panel operation, the start command is detected by the control portion 2. In any of these types of processing described above, the target pattern 80 of the object to be cut 20 is read by the reading unit 41, and the second image data is generated as a result of the reading. The direct cut processing is processing in which the cutting data is generated on the basis of the reading result of the target pattern 80 of the object to be cut 20, and the target pattern 80 of the object to be cut 20 is cut out in accordance with the generated cutting data. The scan to cut data processing is processing in which the cutting data is generated on the basis of the reading result of the target pattern 80 of the object to be cut 20, and the generated cutting data is stored. The scan to USB processing is processing in which the reading result of the object to be cut 20 is output to the USB memory 60. The background scan is a command to execute processing to output the reading result of the object to be cut 20 to the LCD 51. The background scan is selected, for example, when part of a design is needed to be removed from a material on which a design is present. A case will be explained, with reference to FIG. 2, in which the object to be cut 20 including the star-shaped target pattern 80 is used as the object to be cut 20. The support member 10 that supports the object to be cut 20 is placed in a correct position before the start command is input. A color of the target pattern 80 is a different color (red, for example) from a color (white, for example) of the first area 64 and the second area 65.

As shown in FIG. 4, in the main processing, the control portion 2 determines whether the specified processing mode is the first mode (step S1). The processing at step S1 is processing to identify whether the specified mode is the first mode that generates the cutting data on the basis of the second image data generated by reading the support area 67, and a second mode that does not generate the cutting data on the basis of the second image data. When the direct cut processing or the scan to cut data processing is selected, the control portion 2 determines that the specified mode is the first mode. When the scan to USB processing or the background scan is selected, the control portion 2 determines that the specified mode is the second mode.

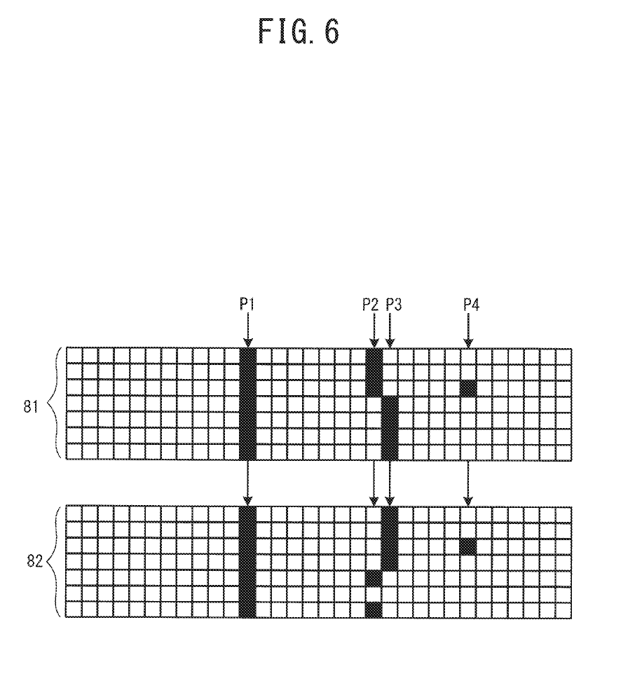

When the specified mode is the second mode (no at step S1), the control portion 2 ends the main processing after performing other processing in accordance with an input command (step S21). In the other processing, processing to detect the abnormal pixels (to be described later) is not performed. When the specified mode is the first mode (yes at step S1), the control portion 2 starts processing to control the conveyance portion 7 and convey the support member 10 in the sub-scanning direction (step S2). In this case, the control portion 2 conveys the support member 10 from the front to the rear of the cutting device 1 at a predetermined speed. The control portion 2 causes the reading unit 41 to read the determination area 66 and the support area 67 of the support member 10 supporting the object to be cut 20 including the target pattern 80, while causing the support member 10 to be conveyed in the sub-scanning direction. The control portion 2 controls the reading unit 41 and reads the first area 64 (step S3), then causes the reading unit 41 to generate the first image data representing the first area 64. For example, the control portion 2 identifies the position of the first area 64 read by the reading unit 41 on the basis of an identification result of the rear end of the support member 10 by the detection sensor 76, a drive amount of the conveyance portion 7 from a point in time at which the rear end of the support member 10 is identified, and a position of the first area 64 of the support member 10 stored in the flash memory 74. The control portion 2 drives the reading unit 41 during a period of time in which the first area 64 is in a reading area of the reading unit 41, and causes the reading unit 41 to generate the first image data representing the first area 64 (refer to FIG. 6). A range of the first area 64 in the main scanning direction includes a range of the support area 67 in the main scanning direction. A range of the first area 64 in the sub-scanning direction is narrower than a range of the support area 67 in the sub-scanning direction. The first image data is data representing a pixel group 81. The pixel group 81 is a group of (N×M) pixels in which a number N of the pixels (represented by a square graphic) are arrayed in the main scanning direction and a number M of the pixels are arrayed in the sub-scanning direction. N and M are natural numbers determined in accordance with a size of the first area 64, a resolution of the reading unit 41 and the like.

The control portion 2 detects the abnormal pixels in the first image data representing the first area 64 generated at step S3, and identifies, as candidate positions, the positions of the abnormal pixels in the main scanning direction (step S4). The color of the first area 64 and the second area 65 of the support member 10 is the same color over the whole range of the first area 64 and the second area 65 (white, for example). Normally, a value of each of the pixels of the pixel group representing the first area 64 and the second area 65 is the same value. It is thus possible to detect, as the abnormal pixel, the pixel having a value that is different to the value of the adjacent pixel in the main scanning direction, in the first image data representing the first area 64. The pixel having the different value to the value of the adjacent pixel may be the pixel which has a difference in a luminance value from the adjacent pixel that is equal to or greater than a predetermined value. For example, when the value of the pixel is expressed as 128 gradations from 0 to 127, when the difference in the luminance value from the adjacent pixel is 5 or more, the pixel may be determined to have the value that is different from the adjacent pixel in the main scanning direction. There is a case in which even when the difference in the luminance value between a target pixel, which is the pixel having a different value from the adjacent pixel in the first image data, and the adjacent pixel is less than the predetermined value, the adjacent pixel is the pixel determined as the abnormal pixel. In this case, the control portion 2 may determine that the target pixel is the abnormal pixel. The abnormal pixel may be detected on the basis of a comparison result between a luminance value of the first image data representing the first area 64, and a luminance value corresponding to the color of the first area 64 stored in the flash memory 74. As shown in FIG. 6, in the pixel group 81, the pixels shown in black are the abnormal pixels. Of the pixel group 81, positions P1 to P4 are identified as the candidate positions. The candidate positions are represented by two-dimensional coordinates (refer to FIG. 6) of the image coordinate system. In addition to identifying the candidate positions, the control portion 2 identifies a number of the abnormal pixels in the sub-scanning direction at the positions P1 to P4. The number of the abnormal pixels at the positions P1 to P4 representing the first area 64 are 7, 3, 4 and 1, respectively.

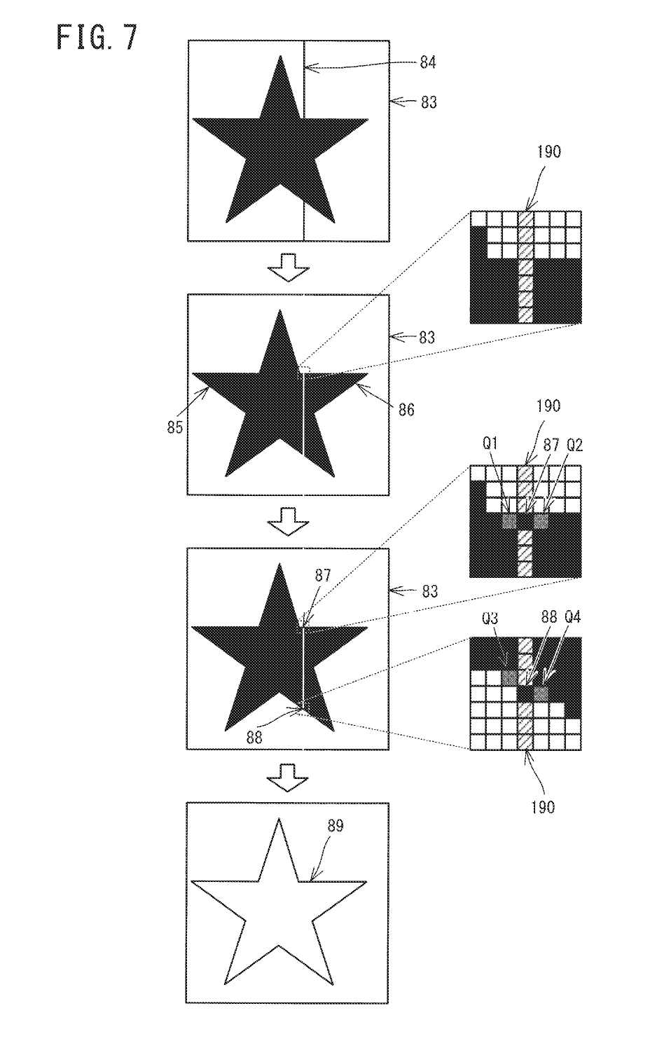

At step S5, the control portion 2 reads the support area 67 by controlling the reading unit 41 (step S5), and causes the second image data representing the support area 67 to be generated. For example, the control portion 2 identifies the support area 67 using the same method of processing as at step S3, and causes the reading unit 41 to generate the second image data. In a specific example, the second image data representing a second image 83 shown in FIG. 7 is generated. A position in the main scanning direction of the second image 83 in the second image data, and a position in the main scanning direction of the pixel group 81 represented by the first image data are associated with each other and aligned with each other.

The control portion 2 determines whether the candidate positions have been identified at step S4 (step S6). When the abnormal pixels are not detected in the first image data obtained by reading the first area 64 and the candidate positions are not identified (no at step S6), the control portion 2 does not perform detection processing for the first image data of the second area 65. In this case, the control portion 2 stops the conveyance of the support member 10 by controlling the conveyance portion 7 (step S24). The control portion 2 generates the cutting data to cut the target pattern 80 of the object to be cut 20 on the basis of the second image data generated by reading the support area 67 (step S25 to step S27). Specifically, the control portion 2 acquires the second image data generated at step S5 (step S25). The control portion 2 identifies a contour of the target pattern 80 represented by the acquired second image data (step S26). The control portion 2 generates the cutting data to cut out the target pattern 80 on the basis of the identified contour (step S27). Known methods (such as methods disclosed in Japanese Laid-Open Patent Publication No. 2014-178824, for example) may be adopted as appropriate as the method for identifying the contour of the target pattern 80 from the second image data, and the method for generating the cutting data to cut out the target pattern 80 on the basis of the identified contour. For example, the control portion 2 generates the cutting data to cut out the target pattern 80 along a contour that is the outermost side of the identified contour.

On the other hand, when the abnormal pixels are detected in the first image data obtained by reading the first area 64 and the positions P1 to P4 are identified as the candidate positions (yes at step S6), the control portion 2 detects the abnormal pixels for the first image data of the second area 65 (step S7 to step S10). In the same manner as the processing at step S3, the control portion 2 reads the second area 65 by controlling the reading unit 41 (step S7) and generates the first image data representing a pixel group 82 shown in FIG. 6. The pixel group 82 of the first image data is a pixel group of the same size as the pixel group 81, and is the group of (N×M) pixels in which the number N of the square-shaped pixels are arrayed in the main scanning direction and the number M of the pixels are arrayed in the sub-scanning direction. N and M are the natural numbers determined in accordance with the size of the first area 64, the resolution of the reading unit 41 and the like. The pixel groups 81 and 82 may be the same size and the same shape as each other, or may be different from each other. By controlling the conveyance portion 7, the control portion 2 stops the conveyance of the support member 10, which is started by the processing at step S2 (step S8).

In the first image data obtained by reading the second area 65 in the processing at step S7, the control portion 2 performs detection of the abnormal pixels in positions corresponding to the candidate positions in the main scanning direction identified in the processing at step S4, and identifies the positions in the main scanning direction of the detected abnormal pixels (step S9). As in the pixel group 82 shown in FIG. 6, for the pixels whose positions in the main scanning direction are the positions P1 to P4, the control portion 2 detects the abnormal pixels on the basis of whether or not the value of the pixel is different to the adjacent pixel. Further, the control portion 2 stores the number of the abnormal pixels in the candidate positions identified in the processing at step S4 in association with a number of the abnormal pixels detected in the processing at step S9. The number of the abnormal pixels in the positions P1 to P4 in the pixel group 82 representing the second area 65 are 7, 2, 4 and 1, respectively. Meanwhile, of the pixel group 82, the control portion 2 does not determine whether the pixels are the abnormal pixels in a case where the positions of the pixels in the main scanning direction do not correspond to the positions P1 to P4.

The control portion 2 determines whether the specific position has been detected (step S10). When the abnormal pixels are continuously present for the predetermined number or more in the sub-scanning direction at the same position in the main scanning direction, the control portion 2 detects that the same position in the main scanning direction as the specific position. The specific position is identified on the basis of a detection result of the abnormal pixels in the first image data obtained by reading the first area 64, and a detection result of the abnormal pixels in the first image data obtained by reading the second area 65. The predetermined number is a number that is equal to or greater than 1, and equal to or less than the number of pixels in the sub-scanning direction in the first image data. The predetermined number may be set as appropriate while taking into account the number of pixels in the sub-scanning direction, the resolution and the like. For example, the predetermined number is a number that is equal to or greater than half the number of pixels in the sub-scanning direction, and also equal to or less than the number of pixels in the sub-scanning direction. When the specific position is not detected (no at step S10), the control portion 2 performs processing at step S18 to be described later, after performing the above-described processing at step S25 to step S27.

On the other hand, when dust, dirt or the like has attached to the reading unit 41, the abnormal pixels that are continuous in the sub-scanning direction appear, as in the position P1. Assuming that the predetermined number is the number of pixels of the first image data in the sub-scanning direction, the predetermined number is set as 14. In the pixel group 81 representing the first area 64 and the pixel group 82 representing the second area 65, the number of abnormal pixels at the positions P1 to P4 are 14, 5, 8 and 2, respectively, and the number of abnormal pixels continuous in the sub-scanning direction are 14, 3, 8 and 1, respectively. Thus, the control portion 2 can detect the position P1, in which the number of abnormal pixels that are continuous in the sub-scanning direction is equal to or greater than the predetermined number 14, as the specific position (yes at step S10). In this case, the control portion 2 causes the LCD 51 to perform notification that the specific position has been detected (step S11). For example, the control portion 2 controls the LCD 51 and causes a message indicating that the specific position has been detected to be displayed on the LCD 51.

The control portion 2 determines whether to generate the cutting data on the basis of the second image data, in accordance with at least one of a number of the specific positions in the main scanning direction and positions of the specific positions in the main scanning direction (step S12). Determination conditions at step S12 may be set as appropriate while taking into account the resolution, the size of the target pattern 80, a correction accuracy and the like. For example, when a predetermined number (5, for example,) of specific positions are continuous in the main scanning direction, the control portion 2 determines that the cutting data is not to be generated on the basis of the second image data (no at step S12). Further, for example, when the position of the specific position in the main scanning direction is a corner position in the left-right direction of the second image data, the control portion 2 may determine that the cutting data is to be generated (yes at step S12).

When it is determined that the cutting data is not to be generated on the basis of the second image data (no at step S12), the control portion 2 performs notification of a method of action on the LCD 51 (step S22). In this case, by performing the notification of the method of action on the LCD 51, the control portion 2 prompts the user to cause the reading unit 41 to be in a state in which the dust, dirt and the like are removed. For example, the control portion 2 causes the LCD 51 to notify a cleaning method as the method of action, in which the dust and dirt etc. attached to the reading unit 41 are wiped away. The method of action need not necessarily be the cleaning method, and the control portion 2 may notify a part replacement method for the reading unit 41. After causing the reading unit 41 to be in the state in which the dust, dirt and the like are removed, in accordance with the notified method of action, the user once more inputs the reading command by the panel operation. The control portion 2 stands by until the reading command is acquired once more from the user (no at step S23). When the reading command has once more been acquired (yes at step S23), the control portion 2 returns the processing to step S2. As a result of the command to once more perform the reading, the user can return the position of the support member 10 in the conveyance direction to a conveyance start position at step S2, as necessary, by causing the control portion 2 to control the conveyance portion 7.

On the other hand, when it is determined that the cutting data is to be generated (yes at step S12), the control portion 2 generates the cutting data on the basis of the second image data (step S13 to step S17). On the basis of the second image data and the specific position detected by the processing at step S10, the control portion 2 identifies the contour of the target pattern 80 represented by the second image data, and generates the cutting data to cut the target pattern 80 of the object to be cut 20. More specifically, the control portion 2 acquires the specific position detected at step S10 and the second image data generated by the reading of the support area 67 in the processing at step S5 (step S13). On the basis of the acquired second image data, the control portion 2 sets a value of a specific pixel group 190, whose position in the main scanning direction is the specific position, to a predetermined value, and removes a line segment 84 that appears in the specific position (step S14). The predetermined value is, for example, selected as appropriate from the values expressing the colors of the determination area 66 and the support area 67. As shown in FIG. 7, on the support member 10, the colors of the determination area 66 and the support area 67 are the same color, namely, white. Of the second image data, the control portion 2 sets the value of the specific pixel group 190, whose position in the main scanning direction is the specific position and which is indicated by shading using diagonal lines in FIG. 7, to a value corresponding to the color white. In this way, the control portion 2 removes the line segment 84 appearing in the specific position in the image represented by the second image data, as shown in the second diagram from the top in FIG. 7. By correcting the specific pixel group 190 to the color white, the pattern represented by the first image data is divided into a first pattern 85 and a second pattern 86. The first pattern 85 is positioned leftward with respect to the specific pixel group 190 in the main scanning direction and the second pattern 86 is positioned rightward with respect to the specific pixel group 190 in the main scanning direction.

In the second image data from which the line segment 84 has been removed, the control portion 2 sets, inside the specific pixel group 190, a connection graphic that connects the first pattern 85 positioned to the left side of the specific pixel group 190 in the main scanning direction, and the second pattern 86 positioned to the right side (step S15). As the connection graphic, the control portion 2 sets, in the second image data from which the line segment 84 has been removed, a line segment that connects a pixel Q1 (Q3), which forms a first vertex of the first pattern 85 that is in contact with the specific pixel group 190, with a pixel Q2 (Q4), which forms a second vertex of the second pattern 86 that is closest to the first vertex and that is in contact with the specific pixel group 190. Specifically, in the processing at step S15, two connection graphics 87 and 88 are set. The connection graphic 87 is a graphic connecting the pixel Q1, which forms the first vertex that is in contact with the specific pixel group 190 at the rear of the pixels representing the first pattern 85, with the pixel Q2, which forms the second vertex that is in contact with the specific pixel group 190 of the pixels representing the second pattern 86, and that is closest to the pixel Q1. In FIG. 7, since the removed data is a line segment of a single pixel, the connection graphic 87 is the single pixel. Similarly, the connection graphic 88 is a graphic connecting the pixel Q3, which forms the first vertex that is in contact with the specific pixel group 190 at the front of the pixels representing the first pattern 85, with the pixel Q4, which forms the second vertex that is in contact with the specific pixel group 190 of the pixels representing the second pattern 86, and that is closest to the pixel Q3. As shown in FIG. 7, since the removed data is a line segment of a single pixel, the connection graphic 88 is the single pixel. Note that the connection graphic may be a graphic represented by a plurality of pixels. In this case, for example, this means that a removed line segment extending in the sub-scanning direction is not configured by data of a single pixel in the main scanning direction, is configured by a plurality of pixels aligned in the main scanning direction, and is the line segment extending in the sub-scanning direction.

The control portion 2 identifies a contour 89 of the target pattern 80 that includes the first pattern 85, the second pattern 86, and the connection graphics 87 and 88 (step S16), which are represented by the second image data in which the connection graphics 87 and 88 have been set by the processing at step S15. The control portion 2 generates the cutting data on the basis of the identified contour 89 (step S17). A known method may be adopted as appropriate for the processing to identify the contour 89, similarly to the processing at step S26. A known method may be adopted as appropriate for the processing to generate the cutting data to cut the target pattern 80 on the basis of the identified contour 89, similarly to the processing at step S27. The cutting data is generated to cut out the target pattern 80 along the identified contour 89.

The control portion 2 determines whether the commanded processing is the direct cut processing (step S18). When the commanded processing is not the direct cut processing (no at step S18), the control portion 2 stores the cutting data generated at step S17 in a storage device such as the flash memory 74 (step S28), and ends the processing. When the commanded processing is the direct cut processing (yes at step S18), the control portion 2 performs cutting processing (step S19). The cutting processing is processing to cut the target pattern 80 of the object to be cut 20 by controlling the conveyance portion 7 and the movement portion 8 in accordance with the cutting data generated by the processing at step S17 or step S27. The object to be cut 20 is cut along the identified contour 89 of the target pattern 80 (refer to FIG. 7). The control portion 2 ends the processing.

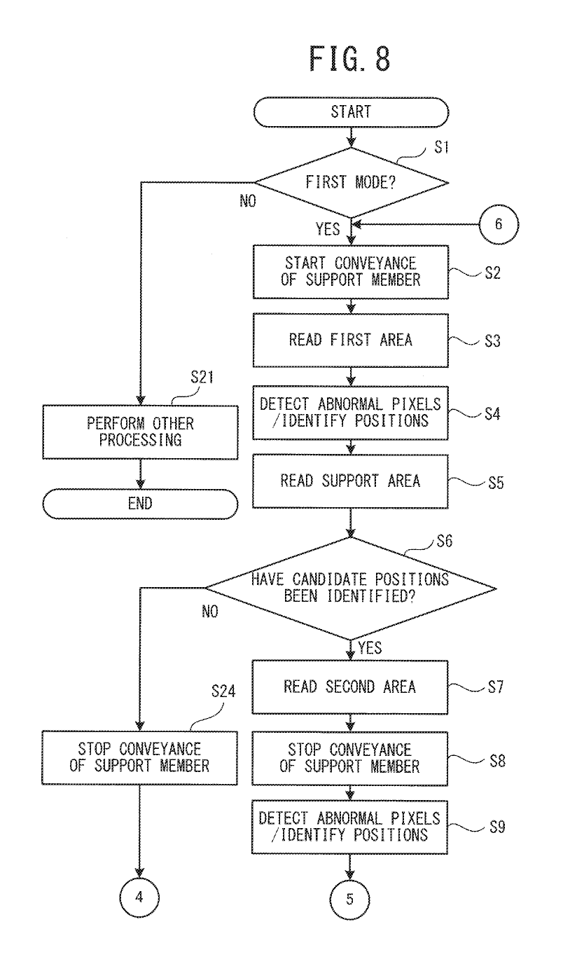

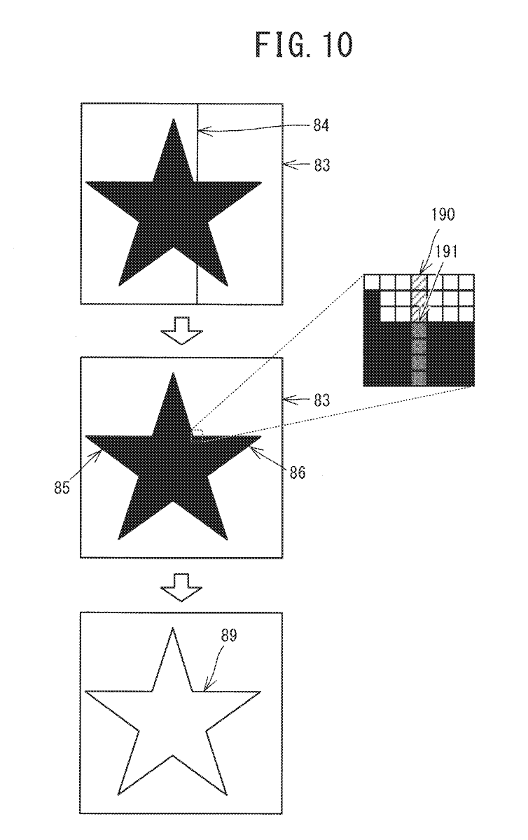

Main processing according to the second embodiment will be explained with reference to FIG. 8 and FIG. 10. In FIG. 8, the same step numbers are assigned as to the processing that is the same as that of the first embodiment. As shown in FIG. 8, the main processing of the second embodiment differs from the main processing of the first embodiment in that, in place of the processing at step S12, processing at step S31 is performed, and, in place of the processing at step S14 and S15, processing at step S32 is performed. In the main processing of the second embodiment, processing other than that at steps S31 and S32 is the same as the main processing of the first embodiment. Thus, an explanation of the processing that is the same as the first embodiment is omitted. The explanation below is given for performing the processing at steps S31 and S32, which are different to the first embodiment. When the start command is input by the panel operation in the same manner as in the first embodiment, the control portion 2 of the cutting device 1 reads out, to the RAM 73, the cutting program stored in the flash memory 74, and performs the main processing in accordance with the commands included in the cutting program. In a specific example, a case will be explained in which the object to be cut 20 including the star-shaped target pattern 80 is used as the object to be cut 20, in the same manner as the first embodiment.

At step S31, the control portion 2 determines whether a wiping command to perform wiping processing has been acquired. In the main processing of the second embodiment, when the specific position has been identified, on the basis of a notification result at step S11, the user inputs, to the cutting device 1, a command as to whether or not to perform predetermined processing on the reading unit 41. When the wiping command has been acquired (yes at step S31), the control portion 2 performs the processing at step S22 in the same manner as the first embodiment. When the wiping command has not been acquired (no at step S31), the control portion 2 performs the processing at step S13 in the same manner as the first embodiment.

At step S32, in the second image data, the value of the specific pixel group 190 whose position in the main scanning direction is the specific position is corrected to the value of the adjacent pixels in the main scanning direction and a replacement graphic 191 that represents a part of the target pattern 80 is set inside the specific pixel group 190 (step S32). A range of the adjacent pixels is set as appropriate. For example, the control portion 2 sequentially reads, in the sub-scanning direction, the pixels of the specific pixel group 190 whose position in the main scanning direction is the specific position. The control portion 2 corrects the value of the target pixel of the read specific pixel group 190 to the value of at least one of the pixels in contact with the target pixel in the main scanning direction. The control portion 2 may correct the value to a representative value (an average value, a median value, or a mode value, for example) obtained using a range of 3 pixels in the main scanning direction and 3 pixels in the sub-scanning direction that center on the target pixel. As shown in FIG. 10, the control portion 2 corrects the value of the specific pixel group 190 to the value of the adjacent pixels in the main scanning direction. The control portion 2 sets the replacement graphic 191 that represents a part of the target pattern 80 inside the specific pixel group 190. The replacement graphic 191 is indicated by dotted shading in FIG. 10. The replacement graphic 191 is a line segment shaped graphic that extends in the front-rear direction. Similarly to the first embodiment, the first pattern 85 and the second pattern 86 are disposed on both sides of the replacement graphic 191 in the main scanning direction. In the processing at step S16, the control portion 2 identifies a graphic represented by the second image data in which the replacement graphic 191 is set, namely, identifies the contour 89 of the target pattern 80 including the first pattern 85, the second pattern 86, and the replacement graphic 191 (step S16). The control portion 2 generates the cutting data on the basis of the identified contour 89 (step S17).

According to the cutting device 1 of the first and second embodiments, it is possible to detect the case in which the dirt, dust is attached to the reading unit 41 or the like, on the basis of the first image data generated by reading the determination area 66. The cutting device 1 can cut the target pattern 80 on the basis of the generated cutting data.

The control portion 2 identifies the contour 89 of the target pattern 80 represented by the second image data on the basis of the second image data and the specific position detected at step S10 (step S16). Further, the control portion 2 generates the cutting data on the basis of the identified contour 89 (step S17). Therefore, the cutting device 1 can generate the cutting data to cut the target pattern 80 while taking into account the case in which the dust, or dirt is attached to the reading unit 41 or the like.

The control portion 2 of the first embodiment removes the line segment 84 appearing in the specific position by correcting, in the second image data, the value of the specific pixel group 190 whose position in the main scanning direction is the specific position to the predetermined value (step S14). The control portion 2 sets, inside the specific pixel group 190, the connection graphics 87 and 88 that connect the first pattern 85 and the second pattern 86 positioned on both sides, in the main scanning direction, of the specific pixel group 190 in the second image data from which the line segment 84 has been removed (step S15). The control portion 2 identifies the contour 89 of the target pattern 80 that includes the first pattern 85, the second pattern 86, and the connection graphics 87 and 88, which are represented by the second image data in which the connection graphics 87 and 88 have been set (step S16). The control portion 2 generates the cutting data on the basis of the identified contour 89 that includes the first pattern 85, the second pattern 86, and the connection graphics 87 and 88 (step S17). Therefore, the cutting device 1 can eliminate the influence of the line segment 84 that appears in the specific pixel group 190 whose position in the main scanning direction is the specific position and which is caused by the dust, or dirt being attached to the reading unit 41 or the like, and can generate the cutting data to cut the target pattern 80.

The control portion 2 of the first embodiment sets, as the connection graphics 87 and 88, the line segments connecting the first vertex and the second vertex. The first vertex is the vertex (the pixels Q1, Q3) of the first pattern 85 that is in contact with the specific pixel group 190 in the second image data from which the line segment 84 has been removed. The second vertex is the vertex (the pixels Q2, Q4) of the second pattern 86 that is in contact with the specific pixel group 190 and that is closest to the pixels Q1, Q3 forming the first vertex. Therefore, the cutting device 1 can eliminate the influence of the line segment 84 that appears in the specific pixel group 190 whose position in the main scanning direction is the specific position, using relatively simple processing, and can generate the cutting data to cut the target pattern 80.

The control portion 2 of the second embodiment corrects, in the second image data, the value of the specific pixel group 190 whose position in the main scanning direction is the specific position to the value of the adjacent pixels in the main scanning direction. The control portion 2 sets, inside the specific pixel group 190, the replacement graphic 191 that represents a part of the target pattern 80 (step S32). The control portion 2 identifies the contour 89 of the target pattern 80 in which the replacement graphic 191 have been set (step S16). The control portion 2 generates the cutting data on the basis of the identified contour 89 including replacement graphic 191 (step S17). Therefore, the cutting device 1 can eliminate the influence of the line segment 84 that appears in the specific pixel group 190 whose position in the main scanning direction is the specific position, using relatively simple processing, and can generate the cutting data to cut the target pattern 80.

The determination area 66 of the cutting device 1 of the first and second embodiments include the first area 64 and the second area 65 positioned on both sides of the support area 67 in the sub-scanning direction. The control portion 2 detects that the same position in the main scanning direction as the specific position when, in the first area 64 and the second area 65, the abnormal pixels are continuously present for the predetermined number or more in the sub-scanning direction at the same position in the main scanning direction (step S10). Therefore, the cutting device 1 can more correctly detect the specific position compared to a case in which the specific position is detected on the basis of only one of the first area 64 and the second area 65.

The control portion 2 detects the abnormal pixels in the first image data of the second area 65 (step S9) when the abnormal pixels are detected in the first image data obtained by reading the first area 64 (yes at step S6). The control portion 2 does not detects the abnormal pixels in the first image data of the second area 65 when the abnormal pixels are not detected in the first image data obtained by reading the first area 64 (no at step S6). In this case, the control portion 2 identifies the contour of the target pattern 80 represented by the second image data (step S26). The control portion 2 generates the cutting data on the basis of the identified contour of the target pattern 80 (step S27). When the candidate positions have not been identified, the cutting device 1 can avoid performing the detection processing on the first image data of the second area 65.

The control portion 2 identifies, as the candidate positions, the positions of the abnormal pixels in the main scanning direction (step S4) when the abnormal pixels are detected in the first image data obtained by reading the first area 64 (yes at step S6). The control portion 2 detects the abnormal pixels in a position corresponding to the candidate positions in the main scanning direction, in the first image data obtained by reading the second area 65 (step S9). The control portion 2 detects the same position in the main scanning direction as the specific position, on the basis of the detection result of the abnormal pixels in the first image data obtained by reading the first area 64 and the detection result of the abnormal pixels in the first image data obtained by reading the second area 65, when the abnormal pixels are continuously present for the predetermined number or more in the sub-scanning direction, at the same position in the main scanning direction (step S10). The cutting device 1 can detect the specific position on the basis of the detection results of the abnormal pixels in both the first area 64 and the second area 65. The predetermined number is a value that is larger than the number of pixels in the sub-scanning direction of each of the first area 64 and the second area 65. Therefore, the cutting device 1 can avoid the specific position being detected when the abnormal pixels are detected in only one of the first area 64 and the second area 65.

The control portion 2 of the first and second embodiments identifies whether the processing mode is one of the first mode and the second mode (step S1). The first mode is a mode that generates the cutting data on the basis of the second image data. The second mode is a mode that does not generate the cutting data on the basis of the second image data. The control portion 2 detects the specific position on the basis of the first image data (steps S3, S4, S6, S7, S9, and S10) when the first mode is identified in the processing at step S1 (yes at step S1). The control portion 2 does not detect the specific position on the basis of the first image data when the second mode is identified (no at step S1). Therefore, the cutting device 1 can perform the processing to detect the specific position when the cutting data is to be generated, and can avoid performing the processing to detect the specific position when the detection of the specific position is not necessary.

The cutting device 1 of the first and second embodiments is provided with the LCD 51 that notify the information. The control portion 2 causes the LCD 51 to notify the information when the specific position is detected (step S11). Therefore, the cutting device 1 can notify the user that the specific position has been detected. On the basis of the notification result, the user can take action to remove the dust, dirt attached to the reading unit 41 or the like, to replace parts and so on.

The control portion 2 determines whether to generate the cutting data on the basis of the second image data, in accordance with at least one of the number of specific positions and the positions of the specific positions in the main scanning direction (step S12). The control portion 2 causes the LCD 51 to notify the information indicating the method of action (step S22) when it is determined not to generate the cutting data on the basis of the second image data (no at step S12). The control portion 2 generates the cutting data on the basis of the second image data (step S17) when it is determined that the cutting data is to be generated (yes at step S12). The cutting data is not generated on the basis of the second image data when it is determined that the cutting data is not to be generated (no at step S12). The cutting device 1 can automatically determine whether or not to generate the cutting data on the basis of the second image data, in accordance with at least one of the number of the detected specific positions and the positions of the specific positions in the main scanning direction. When the amount of the dust, dirt attached to the reading unit 41 is comparatively large or the like, for example, the cutting device 1 can prompt the user to remove the dust, dirt or the like. On the other hand, when the amount of the dust, dirt attached to the reading unit 41 or the like is comparatively small, the cutting device 1 can generate the cutting data on the basis of the second image data.

The cutting device of the present disclosure is not limited to the above-described embodiments, and various changes may be added insofar as they do not depart from the scope and spirit of the present disclosure. For example, the configuration of the cutting device 1 may be changed as appropriate. The cutting device 1 may be capable of performing processing other than cutting, such as drawing or the like, in addition to the cutting by the cutting blade 16. The cutting device 1 need not necessarily be provided with the LCD 51. The cutting device 1 may be provided with a device other than the LCD 51, such as a speaker or the like, as a notification portion that notifies the information.

For the main processing shown in FIG. 6, a microcomputer, application specific integrated circuits (ASICs), a field programmable gate array (FPGA) and the like may be used as the processor, in place of the control portion 2. The main processing may be performed as distributed processing by a plurality of processors. The flash memory 74 that stores the cutting program for performing the main processing may be configured, for example, by another non-transitory storage medium, such as an HDD and/or an SSD. It is sufficient that the non-transitory storage medium be capable of accumulating information, irrespective of a time period of storing the information. The non-transitory storage medium need not necessarily include a transitory storage medium (a transmitted signal, for example). The cutting program for performing the main processing may be downloaded from a server connected via a network (not shown in the drawings) (namely, may be transmitted as a transmission signal), and stored in the HDD, for example. In this case, the cutting program may be stored in a non-transitory storage medium, such as an HDD, provided in the server. An order of each of the steps of the main processing of the above-described embodiments can be changed, or steps can be omitted and added as necessary. A case in which a part or all of the actual processing is performed by an operating system (OS) or the like operating on the cutting device 1, on the basis of commands from the control portion 2 of the cutting device 1, and the functions of the above-described embodiments are realized by that processing is also included in the scope of the present disclosure.

The control portion 2 need not necessarily generate the cutting data to cut the target pattern 80 of the object to be cut 20 on the basis of the second image data and the specific position detected at step S10. In this case, when the specific position is identified (yes at step S10), the control portion 2 may omit the processing at step S12 and perform notification of the method of action (step S22).

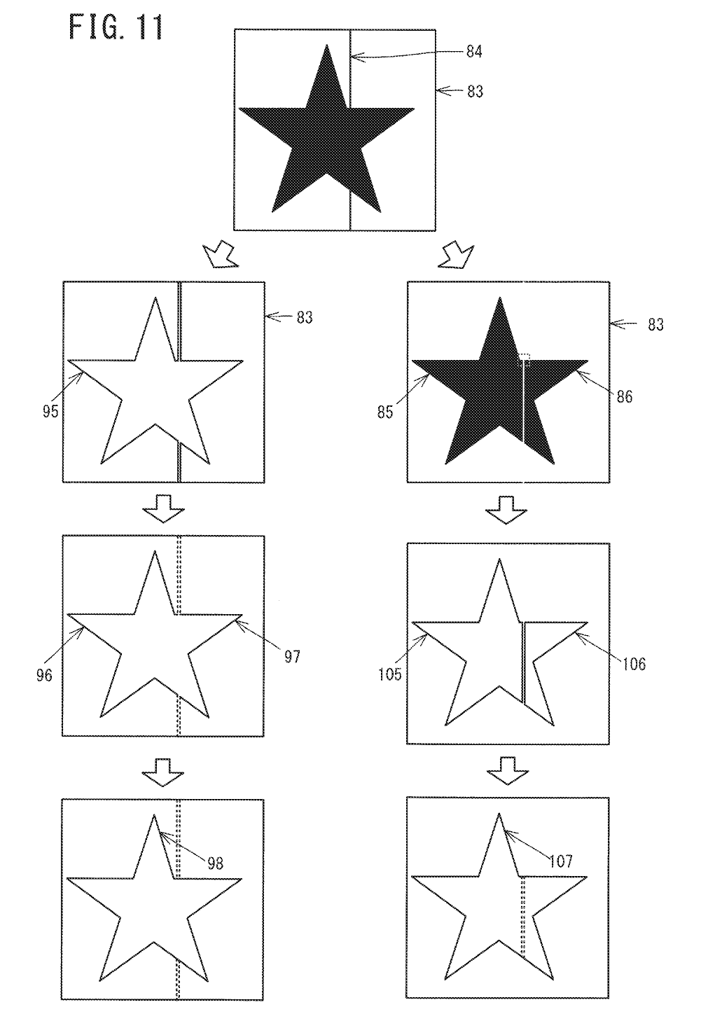

In the second image data, the control portion 2 need not necessarily set the value of the specific pixel group, whose position in the main scanning direction is the specific position, to the predetermined value and remove the line segment appearing in the specific position. In this case, the control portion 2 may use, for example, the method indicated below to generate the cutting data. As shown on the left side in FIG. 11, the control portion 2 identifies a contour 95 of the target pattern 80 including line segments and generates the cutting data to cut along the contour (a line segment group 98). Of the line segments represented by the generated cutting data, the control portion 2 removes sections indicated by dotted lines that are in contact with a specific pixel group. The control portion 2 joins line segments 96 and 97 that have been divided by removing the dotted line sections, and generates the cutting data representing the line segment group 98.

The control portion 2 need not necessarily set, as the connection graphic, the line segment that connects the first vertex of the first pattern that is in contact with the specific pixel group in the second image data from which the line segment has been removed, and the second vertex of the second pattern that is in contact with the specific pixel group and that is closest to the first vertex. For example, the control portion 2 may set, as the connection graphic, a graphic that fills a space between a side of the first pattern in contact with the specific pixel group and a side of the second pattern in contact with the specific pixel group. The control portion 2 may generate the cutting data using, for example, the method indicated below. As shown on the right side in FIG. 11, the control portion 2 identifies contours 105 and 106 of the first pattern 85 and the second pattern 86 represented by the target pattern 80 from which the line segment 84 has been removed, and generates the cutting data to cut along the contour (a line segment group 107). Of the line segments represented by the generated cutting data, the control portion 2 removes a section indicated by dotted lines that is in contact with the specific pixel group. The control portion 2 identifies the contours 105 and 106. The control portion 2 generates the cutting data that joins the line segments from which the line segment 84 has been removed, and that represents the line segment group 107.

The configuration of the support member 10 may be changed as appropriate. The size, the layout, and the color of the determination area 66, and the number of areas included in the determination area 66 and the like may be changed as appropriate. Similarly, the size, the layout, the color and the like of the support area 67 may be changed as appropriate. The determination area 66 of the cutting device 1 of the first and second embodiments may be one of the first area 64 and the second area 65 positioned on both sides of the support area 67 in the sub-scanning direction. The first area 64 and the second area 65 may be positioned on one side of the support area 67 in the sub-scanning direction. In this case, the first area 64 and the second area 65 may be continuous to each other in the sub-scanning direction, and an order of reading the determination area 66 in the main processing may be changed as appropriate in accordance with the layout of the determination area 66 in the support member 10. It is sufficient that the first area 64 and the second area 65 each have the same color over the whole area of the first area 64 and the second area 65, and the first area 64 and the second area 65 may have the same color or may have different colors. The longitudinal direction of the support member 10 need not necessarily be the conveyance direction of the support member 10 by the cutting device 1. The support member 10 may be configured such that the first area 64 and the second area 65 can be distinguished from each other, or may be configured such that the first area 64 and the second area 65 cannot be distinguished from each other.

The method of detecting the specific position may be changed as appropriate. For example, the specific position may be detected when the abnormal pixels are continuously present for the predetermined number or more in the first image data of the first area 64, and the abnormal pixels are continuously present for the predetermined number or more in the first image data of the second area 65. In this case, it is sufficient that the predetermined number be a number that is equal to or greater than 1, and equal to or less than the number of pixels in the sub-scanning direction in the first image data of each of the areas, and the predetermined number may be the same for the first area 64 and the second area 65 or may be a mutually different number. When the abnormal pixels are continuously present for the predetermined number or more in at least one of the first image data of the first area 64 and the first image data of the second area 65, abnormal pixels may be detected as the specific position.

The control portion 2 may perform the detection processing to detect the abnormal pixels in the first image data of the second area 65, irrespective of whether or not the abnormal pixels are detected in the first image data obtained by reading the first area 64. When the predetermined number or more of the abnormal pixels are detected in the sub-scanning direction in the first image data obtained by reading the first area 64, the control portion 2 may identify the candidate positions and perform the detection processing to detect the abnormal pixels in the first image data of the second area 65. When the abnormal pixels are detected in the first image data obtained by reading the first area 64, the control portion 2 may perform the detection of the abnormal pixels in the whole area of the first image data obtained by reading the second area 65.

The processing to identify the first mode or the second mode may be omitted. When the second mode is identified, the control portion 2 may perform the processing to detect the specific position on the basis of the first image data.

In the cutting device 1 of the first and second embodiments, the control portion 2 need not necessarily perform the notification on the LCD 51 that the specific position has been detected. The processing at step S12 may be omitted as appropriate. When it is determined that the cutting data is not to be generated on the basis of the second image data (no at step S12), the control portion 2 need not necessarily cause the method of action to be notified on the LCD 51. Each of the methods of notification at steps S11 and S22 may be changed as appropriate in accordance with a configuration of the notification portion. In the processing of the cutting device 1 of the first and second embodiments, when the dust, dirt or the like is attached to the reading unit 41, the control portion detects the abnormal pixels and identifies the specific position, but this processing may be used in detection of other abnormal pixels. For example, the processing of the above-described embodiments can be applied in a case where the imaging elements of the line sensor include one pixel or two or more pixels that are dead pixels (abnormal pixels). Note that the dead pixel refers to a pixel for which an output from the pixel of the element is in a constant state and which does not respond to light, for example. When the dead pixel is present in the line sensor, for example, similarly to the case in which the dust, dirt is attached to the reading unit 41 or the like, the abnormal pixels corresponding to the line segment 84 shown in FIG. 7 appear in the second image 83. The method of identifying and processing the abnormal pixels in the above-described embodiments can also be applied to this type of case.

The apparatus and methods described above with reference to the various embodiments are merely examples. It goes without saying that they are not confined to the depicted embodiments. While various features have been described in conjunction with the examples outlined above, various alternatives, modifications, variations, and/or improvements of those features and/or examples may be possible. Accordingly, the examples, as set forth above, are intended to be illustrative. Various changes may be made without departing from the broad spirit and scope of the underlying principles.

What is claimed is:

1. A cutting device comprising:
a support member including a support area configured to support an object to be cut, and a determination area provided on outer sides of the support area and having a same color;
a reading unit including a plurality of imaging elements disposed side by side in a main scanning direction;
a conveyance portion configured to convey the support member in a sub-scanning direction that is orthogonal to the main scanning direction;
a movement portion configured to move, in the main scanning direction, a cutting blade that cuts the object to be cut supported by the support member;
a processor; and
a memory storing computer-readable instructions that, when executed by the processor, instruct the cutting device to perform processes comprising:
conveying the support member in the sub-scanning direction by controlling the conveyance portion;
causing the reading unit to read the support area and the determination area of the support member supporting the object to be cut that includes a target pattern, while the support member is being conveyed in the sub-scanning direction;
detecting a same position in the main scanning direction as a specific position when, in first image data generated by the reading of the determination area, abnormal pixels are continuously present for a predetermined number or more in the sub-scanning direction at the same position in the main scanning direction, each of the abnormal pixels being a pixel having a value that is different to a value of an adjacent pixel in the main scanning direction;
generating cutting data on the basis of second image data generated by the reading of the support area, the cutting data being data for cutting the target pattern from the object to be cut; and
cutting the target pattern from the object to be cut by controlling the conveyance portion and the movement portion in accordance with the generated cutting data.

2. The cutting device according to claim 1, wherein
the generating includes:
identifying a first contour of the target pattern represented by the second image data on the basis of the second image data and the detected specific position; and
generating the cutting data on the basis of the identified first contour.

3. The cutting device according to claim 2, wherein
the computer-readable instructions, when executed by the processor, further instruct the cutting device to perform processes comprising:
removing a first line segment appearing in the specific position, by correcting, in the second image data, a value of a pixel group whose position in the main scanning direction is the specific position to a predetermined value; and
setting, inside the pixel group, a connection graphic that connects a first pattern and a second pattern positioned on both sides, in the main scanning direction, of the pixel group in the second image data from which the first line segment has been removed, and
the generating includes:
identifying the first contour of the target pattern that includes the first pattern, the second pattern, and the connection graphic, which are represented by the second image data in which the connection graphic has been set; and
generating the cutting data on the basis of the identified first contour that includes the first pattern, the second pattern, and the connection graphic.

4. The cutting device according to claim 3, wherein
the setting includes setting, as the connection graphic, a second line segment connecting a first vertex of the first pattern and a second vertex of the second pattern, the first vertex being a vertex of the first pattern that is in contact with the pixel group in the second image data from which the first line segment has been removed, and the second vertex being a vertex of the second pattern that is in contact with the pixel group and that is closest to the first vertex.

5. The cutting device according to claim 2, wherein
the computer-readable instructions, when executed by the processor, further instruct the cutting device to perform processes comprising:
correcting, in the second image data, a value of a pixel group whose position in the main scanning direction is the specific position, to a value of an adjacent pixel in the main scanning direction; and
setting, inside the pixel group, a replacement graphic that represents a part of the target pattern, and
the generating includes:
identifying the first contour of the target pattern in which the replacement graphic has been set; and
generating the cutting data on the basis of the identified first contour including the replacement graphic.

6. The cutting device according to claim 1, wherein
the determination area includes a first area and a second area positioned on both sides of the support area in the sub-scanning direction, and
the detecting includes detecting the same position in the main scanning direction as the specific position when, in the first area and the second area, the abnormal pixels are continuously present for the predetermined number or more in the sub-scanning direction at the same position in the main scanning direction.

7. The cutting device according to claim 6, wherein
the detecting includes:
detecting the abnormal pixels in the first image data of the second area when the abnormal pixels are detected in the first image data obtained by reading the first area; and
not detecting the abnormal pixels in the first image data of the second area when the abnormal pixels are not detected in the first image data obtained by reading the first area, and
the generating includes:
identifying a second contour of the target pattern represented by the second image data when the abnormal pixels are not detected in the first image data obtained by reading the first area; and
generating the cutting data on the basis of the identified second contour of the target pattern.

8. The cutting device according to claim 6, wherein
the detecting includes:
identifying, as candidate positions, positions of the abnormal pixels in the main scanning direction when the abnormal pixels are detected in the first image data obtained by reading the first area;
detecting the abnormal pixels in a position corresponding to the candidate positions in the main scanning direction, in the first image data obtained by reading the second area; and
detecting the same position in the main scanning direction as the specific position on the basis of a first detection result and a second detection result when the abnormal pixels are continuously present for the predetermined number or more in the sub-scanning direction at the same position in the main scanning direction, the first detection result being a detection result of the abnormal pixels in the first image data obtained by reading the first area, and the second detection result being a detection result of the abnormal pixels in the first image data obtained by reading the second area.

9. The cutting device according to claim 1, wherein
the computer-readable instructions, when executed by the processor, further instruct the cutting device to perform a process comprising:
identifying one of a first mode and a second mode, the first mode being a mode that generates the cutting data on the basis of the second image data, and the second mode being a mode that does not generate the cutting data on the basis of the second image data, and
the detecting includes:
detecting the specific position on the basis of the first image data when the first mode is identified; and
not detecting the specific position on the basis of the first image data when the second mode is identified.

10. The cutting device according to claim 1, further comprising:
a notification portion configured to notify information,
wherein
the computer-readable instructions, when executed by the processor, further instruct the cutting device to perform a process comprising:
causing the notification portion to notify the information when the specific position is detected.

11. The cutting device according to claim 10, wherein
the computer-readable instructions, when executed by the processor, further instruct the cutting device to perform processes comprising:
determining whether to generate the cutting data on the basis of the second image data, in accordance with at least one of a number of the specific positions in the main scanning direction and positions in the main scanning direction of the specific positions; and
causing the notification portion to notify the information indicating a method of action in response to determining not to generate the cutting data on the basis of the second image data, and
the generating includes:
generating the cutting data on the basis of the second image data in response to determining to generate the cutting data; and
not generating the cutting data on the basis of the second image data in response to determining not to generate the cutting data.

12. A non-transitory computer-readable medium storing computer-readable instructions that, when executed, instruct a processor of a cutting device provided with a support member, a reading unit, and a conveyance portion to perform processes comprising:
conveying the support member in a sub-scanning direction that is orthogonal to a main scanning direction by controlling the conveyance portion, the support member being configured to support an object to be cut that includes a target pattern, the conveyance portion being configured to convey the support member in the sub-scanning direction that is orthogonal to the main scanning direction;
causing the reading unit to read a support area and a determination area of the support member supporting the object to be cut, while the support member is being conveyed in the sub-scanning direction, the support area being an area in which the support member is configured to support the object to be cut, the determination area being provided on outer sides of the support area and having a same color, and the reading unit including a plurality of imaging elements disposed side by side in the main scanning direction;
detecting a same position in the main scanning direction as a specific position when, in first image data generated by the reading of the determination area, abnormal pixels are continuously present for a predetermined number or more in the sub-scanning direction at the same position in the main scanning direction, each of the abnormal pixels being a pixel having a value that is different to a value of an adjacent pixel in the main scanning direction; and
generating cutting data on the basis of second image data generated by the reading of the support area, the cutting data being data for cutting the target pattern from the object to be cut.

13. The non-transitory computer-readable medium according to claim 12, wherein
the generating includes:
identifying a first contour of the target pattern represented by the second image data on the basis of the second image data and the detected specific position; and
generating the cutting data on the basis of the identified first contour.

14. The non-transitory computer-readable medium according to claim 13, wherein
the computer-readable instructions further instruct the processor to perform processes comprising:
removing a first line segment appearing in the specific position, by correcting, in the second image data, a value of a pixel group whose position in the main scanning direction is the specific position to a predetermined value; and
setting, inside the pixel group, a connection graphic that connects a first pattern and a second pattern positioned on both sides, in the main scanning direction, of the pixel group in the second image data from which the first line segment has been removed, and
the generating includes:
identifying the first contour of the target pattern that includes the first pattern, the second pattern, and the connection graphic, which are represented by the second image data in which the connection graphic has been set; and
generating the cutting data on the basis of the identified first contour that includes the first pattern, the second pattern, and the connection graphic.

15. The non-transitory computer-readable medium according to claim 14, wherein
the setting includes setting, as the connection graphic, a second line segment connecting a first vertex of the first pattern and a second vertex of the second pattern, the first vertex being a vertex of the first pattern that is in contact with the pixel group in the second image data from which the first line segment has been removed, and the second vertex being a vertex of the second pattern that is in contact with the pixel group and is closest to the first vertex.

16. The non-transitory computer-readable medium according to claim 13, wherein
the computer-readable instructions further instruct the processor to perform processes comprising:
correcting, in the second image data, a value of a pixel group whose position in the main scanning direction is the specific position, to a value of an adjacent pixel in the main scanning direction; and
setting, inside the pixel group, a replacement graphic that represents a part of the target pattern, and
the generating includes:
identifying the first contour of the target pattern in which the replacement graphic has been set; and
generating the cutting data on the basis of the identified first contour including the replacement graphic.

17. The non-transitory computer-readable medium according to claim 12, wherein
the determination area includes a first area and a second area positioned on both sides of the support area in the sub-scanning direction, and
the detecting includes detecting the same position in the main scanning direction as the specific position when, in the first area and the second area, the abnormal pixels are continuously present for the predetermined number or more in the sub-scanning direction at the same position in the main scanning direction.

18. The non-transitory computer-readable medium according to claim 17, wherein
the detecting includes:
detecting the abnormal pixels in the first image data of the second area when the abnormal pixels are detected in the first image data obtained by reading the first area; and
not detecting the abnormal pixels in the first image data of the second area when the abnormal pixels are not detected in the first image data obtained by reading the first area, and
the generating includes:
identifying a second contour of the target pattern represented by the second image data when the abnormal pixels are not detected in the first image data obtained by reading the first area; and
generating the cutting data on the basis of the identified second contour of the target pattern.

19. The non-transitory computer-readable medium according to claim 17, wherein
the detecting includes:
identifying, as candidate positions, positions of the abnormal pixels in the main scanning direction when the abnormal pixels are detected in the first image data obtained by reading the first area;
determining the abnormal pixels in the positions that are the candidate positions in the main scanning direction, in the first image data obtained by reading the second area; and
detecting the same position in the main scanning direction as the specific position on the basis of a first detection result and a second detection result when the abnormal pixels are continuously present for the predetermined number or more in the sub-scanning direction at the same position in the main scanning direction, the first detection result being a detection result of the abnormal pixels in the first image data obtained by reading the first area, and the second detection result being a detection result of the abnormal pixels in the first image data obtained by reading the second area.

20. The non-transitory computer-readable medium according to claim 12, wherein
the computer-readable instructions further instruct the processor to perform a process comprising:
identifying one of a first mode and a second mode, the first mode being a mode that generates the cutting data on the basis of the second image data, and the second mode being a mode that does not generate the cutting data on the basis of the second image data, and
the detecting includes:
detecting the specific position on the basis of the first image data when the first mode is identified; and
not detecting the specific position on the basis of the first image data when the second mode is identified.
